(19) United States
(12) Patent Application Publication
(10) Pub. No.: US 2024/0220331 A1
(43) Pub. Date: Jul. 4, 2024

(54) METHODS, SYSTEMS, AND STORAGE MEDIA FOR IMPLEMENTATION OF ENHANCED OPEN DIGITAL ARCHITECTURE FOR SUPPORT SYSTEM

(71) Applicant: RAKUTEN SYMPHONY SINGAPORE PTE. LTD., Singapore (SG)

(72) Inventor: Kumeresh KHANNA, Singapore (SG)

(73) Assignee: RAKUTEN SYMPHONY SINGAPORE PTE. LTD., Singapore (SG)

(21) Appl. No.: 17/917,129

(22) PCT Filed: Jul. 28, 2022
(86) PCT No.: PCT/US2022/038631

§ 371 Date: Feb. 1, 2024

(51) Int. Cl. G06F 9/50; G06F 9/54

(52) U.S. Cl. CPC G06F 9/5055; G06F 9/5077; G06F 9/542

(57) ABSTRACT

Architectures, and methods and systems for implementation thereof are disclosed. A system for implementing business support system (BSS) architecture comprises a memory; and a processor to execute instructions to implement the architecture, which comprises: a plurality of layers, and real-time event streams transferring data between components of the layers, which comprise: an engagement and core commerce management layer for providing a plurality of user interfaces respectively corresponding to a plurality of use cases; an event based automation and user data platform layer comprising real-time customer data and a plurality of automation workflows for executing the plurality of use cases based on real-time customer data; a core BSS components layer; an intelligent management layer for managing insights, model development and execution of batch models; and a cloud infrastructure management layer configured providing cloud functionality for a Software as a Solution (SaaS) implementation of the BSS architecture.

### FIELD

Apparatuses and methods consistent with example embodiments of the present disclosure relate to an enhanced open digital architecture (ODA) for a support system, e.g., a Business Support System (BSS).

### BACKGROUND

Related art BSS ODA architectures (e.g., for Telco systems) are typically composed as a multitier architecture based on engagement management, subscriber management, core commerce management, core production platforms and intelligent management, all of which are integrated though application programming interfaces (APIs). FIG. 1 depicts an example of this related art architecture 100, including an engagement management layer 101, subscriber management sub-layer 103, core commerce sub-layer 104, core production sub-layer 105, and intelligent management layer 106. In the related art architecture, API 102 integration is required across the aforementioned components in order to provide cross-components communication and integration.

This related art architecture, however, does not include real time customer data capabilities and/or event streams or real time data streams (e.g., Kafka Data Streams). The addition/inclusion of micro services and cloud tech stacks do not address these problems, at least without additionally changing the underlying architecture. Micro services alone do not provide more flexibility, better time to market, reduced customization costs, and reduced overall solution costs, as compared to the related art architecture.

Presently, custom use cases are being developed and deployed (i.e., hard coded) as core production components for a BSS solution. This is a major challenge when deploying a BSS solution on a software as a service (SaaS) based subscription model. This SaaS model requires heavy up-front investment to any Telco operator.

Embodiments of the instant disclosure may address these problems, and provide for more flexibility, better time to market, reduced customization costs, and reduced overall solution costs, as compared to the current state of the art architecture, including implementation on micro services and cloud tech stacks.

### SUMMARY

According to an aspect of the disclosure there is provided a system for implementing a business support system (BSS) architecture, the system including at least one memory storing instructions; and at least one processor configured to execute the instructions to implement the BSS architecture. The BSS architecture comprises a plurality of layers, and real-time event streams for transferring real-time event streams of data between components of the plurality of layers, wherein the plurality of layers comprises: an engagement and core commerce management layer for providing a plurality of user interfaces respectively corresponding to a plurality of use cases for the BSS architecture; an event based automation and user data platform layer comprising real-time customer data and a plurality of automation workflows for executing the plurality of use cases based on real-time customer data; a core BSS components layer comprising core BSS components; an intelligent management layer for managing insights, model development and execution of batch models; and a cloud infrastructure management layer configured to provide cloud functionality for a Software as a Solution (SaaS) implementation of the BSS architecture.

In an aspect of the disclosure the BSS architecture may further comprise an Open Application Programming Interface (API) for real time information provisioning of the data between the components.

In an aspect of the disclosure the real-time event streams may be Kafka event streams.

In an aspect of the disclosure the BSS architecture may further comprise management components used across the plurality of layers.

In an aspect of the disclosure, the plurality of user interfaces may be respectively configurable by a customer of the SaaS implementation without hardcoding.

In an aspect of the disclosure the BSS components may be productized to the SaaS implementation.

In an aspect of the disclosure the components of the plurality of layers may be executable as microservices by the at least one processor.

According to another aspect of the disclosure there is provided a method which includes receiving, into a first computer architecture layer, a first user request; deciding, in real time, and via a second computer architecture layer, a category of the first user request; providing, based on the category of the first user request, and via the second computer architecture layer, an automated workflow and customer data platform for data entry and manipulation by the user, wherein the user may make a second request; generating, via a third computer architecture layer, a productized model based on the second user request; and intelligently managing the productized model via a fourth computer architecture layer.

In an aspect of the disclosure, the method may be executed on a cloud computing platform.

In an aspect of the disclosure, the first computer architecture layer may be a core commerce and customer engagement layer.

In an aspect of the disclosure, the first through fourth computer architecture layers may be integrated via an application programming interface.

In an aspect of the disclosure, internal reports on the first through fourth architecture layers may be centralized.

In an aspect of the disclosure, the internal reports may be centralized in the fourth computer architecture layer.

In an aspect of the disclosure, the management of the productized model via the fourth computer architecture layer may be centralized.

Another aspect of the present disclosure relates to a system including one or more hardware processors configured by machine-readable instructions. The one or more processors may be configured to: receive, into a first computer architecture layer, a first user request; decide, in real time, and via a second computer architecture layer, a category of the first user request; provide, based on the category of the first user request, and via the second computer architecture layer, an automated workflow and customer data platform for data entry and manipulation by the user, wherein the user may make a second request; generate, via a third computer architecture layer, a productized model based on the second user request; and intelligently manage the productized model via a fourth computer architecture layer.

Yet another aspect of the present disclosure relates to a non-transient computer-readable storage medium having instructions embodied thereon, the instructions being executable by one or more processors to perform a method, the method including: receiving, into a first computer architecture layer, a first user request; deciding, in real time, and via a second computer architecture layer, a category of the first user request; providing, based on the category of the first user request, and via the second computer architecture layer, an automated workflow and customer data platform for data entry and manipulation by the user, wherein the user may make a second request; generating, via a third computer architecture layer, a productized model based on the second user request; and intelligently managing the productized model via a fourth computer architecture layer.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a related art business support system (BSS) open digital architecture (ODA);

FIG. 2 illustrates an open digital architecture (ODA), in accordance with one or more implementations;

FIG. 3 illustrates an open digital architecture (ODA), in accordance with one or more implementations;

FIG. 4 illustrates a method in accordance with one or more implementations;

FIG. 5 illustrates a system configured as an enhanced open digital architecture (ODA) for a support system, in accordance with one or more implementations; and

FIG. 6 illustrates a method in accordance with one or more implementations.

FIG. 7 is a diagram of an example environment in which systems and/or methods, described herein, may be implemented, according to embodiments;

FIG. 8 is a diagram of example components of one or more devices of FIG. 7, according to embodiments;

### DETAILED DESCRIPTION

The following detailed description refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Embodiments of the disclosure provide a multi-tiered business support system (BSS) architecture with a solution-oriented approach that gives operators (e.g., Telco operators) access to a more flexible ecosystem. Additionally, embodiments allow for the simplification of a software as a service (SaaS) approach for BSS vendors.

Aspects of the disclosure provide a BSS architecture in which Core Commerce and Customer Engagement platforms are merged into a single layer. In addition to improving processing efficiency, such merging allows for the simplification of sales (e.g., agent sales and self-sale) and care processes.

Aspects of the disclosure provide a BSS architecture including an event streaming layer (e.g., a Kafka layer) to complement an API layer. In addition to improving processing efficiency, this introduction reduces over dependency on APIs for data transfers between components. According to aspects of the disclosure, most data transfers are performed through this layer to avoid the complexity of an API data transfer while providing a more efficient traffic throughput. Additionally, with the introduction of the event streaming layer, reports (e.g., usage report, performance report, subscriber profile report, bill payment report, etc.) may be centralized to a data intelligent layer, and individual reports at each component may not be required (though they can be permitted).

Aspects of the disclosure provide a BSS architecture including a workflow automation layer. In addition to improving processing efficiency, this introduction of the workflow automation layer allows for the reduction in the need to make changes to the core solution. Custom use cases can easily and flexibly be deployed at this layer, with upgrades, modifications, versioning, etc., requiring no hardcoding or changes to source code.

Aspects of the disclosure provide a new layer (i.e., workflow automation layer) in a BSS architecture for custom configuration across all BSS products, which is useful for SaaS based solutions. Core BSS components may be tightly productized as SaaS offerings.

According to aspects of the disclosure management components such as log management may be centralized. This can be applied to a portion or all of the management components.

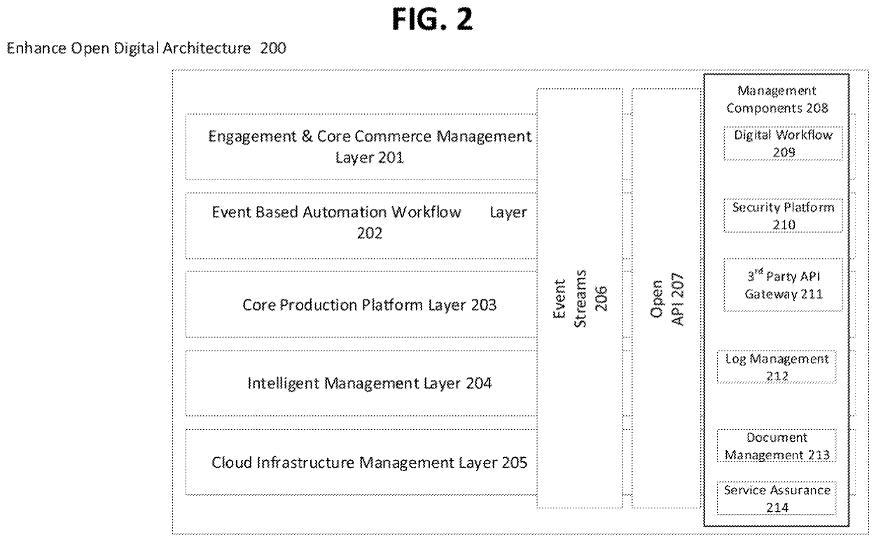

As shown in FIG. 2, each of the different architecture layers 201-205 may be configured as event stream layers via event stream 206 and may be connected via an open API 207. Additionally, the different architecture layers may include management components 208, including digital workflows 209, security platforms 210, a third Party API gateway 211, log management 212, document management 213, and service assurance 214, each of is require for providing operational capabilities for the disclosed architecture. For instance, the digital workflows 209 is configured to provide business workflow (e.g., Business Process Model and Notation (BPMN), etc.), the security platform 210 is configured to provide security-related credentials, the third Party API gateway 211 is configured to provide external component integration, the log management 212 is configured to provide activity log within the architecture, the document management 213 is configured to manage (e.g., store, retrieve, etc.) documents (e.g., reports, contracts, etc.), and the service assurance 214 is configured to assure the service quality (e.g., monitor the system operation to ensure service quality, etc.)

In some embodiments, the event stream 206 is a Kafka event stream. Kafka is a distributed event store and stream-processing platform. It is an open-source system that provides a unified, high-throughput, low-latency platform for handling real-time data feeds. Kafka can connect to external systems (for data import/export) via Kafka Connect, and provides the Kafka Streams libraries for stream processing applications. Kafka uses a binary TCP-based protocol that is optimized for efficiency and relies on a “message set” abstraction that naturally groups messages together to reduce the overhead of the network roundtrip. While Kafka may be used in some embodiments, other real time data streams may be used, and these streams may also be open-source. The use of real time data streams, and microservices create a new restructuring open-source platform.

In some implementations, the method may be executed on a cloud computing platform. In some implementations, first through fourth computer architecture layers 201-204 (and optionally fifth computer architecture layer 205) may be integrated via an application programming interface, e.g., 207. In some implementations, internal reports on the first through fourth architecture layers 201-204 (and optionally fifth computer architecture layer 205) may be centralized. In some implementations, the method may be executed on an event streaming layer, e.g., a computer architecture layer 206.

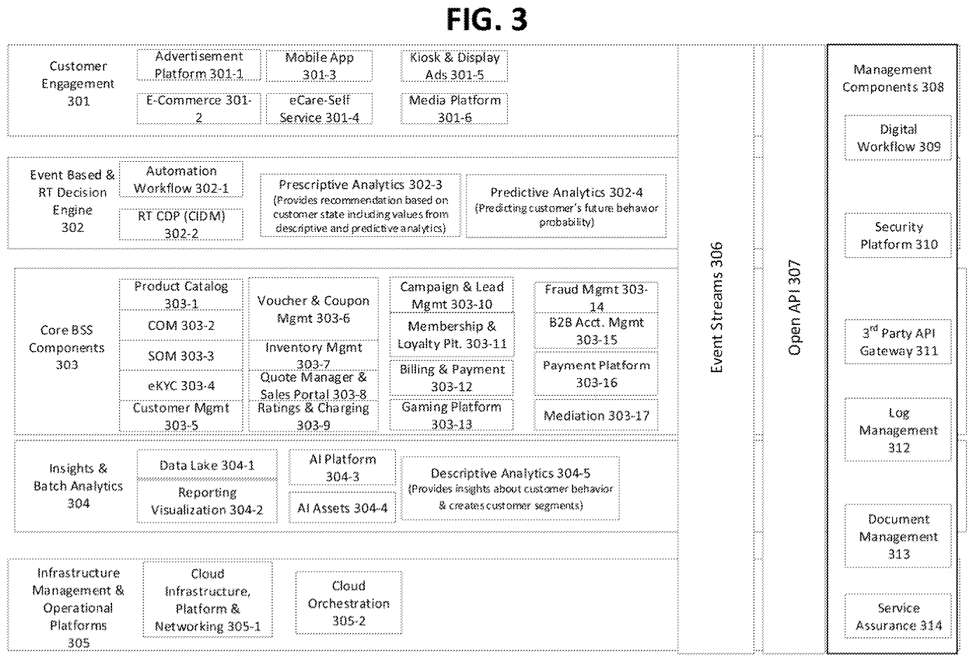

FIG. 3 depicts another embodiment of a BSS ODA architecture. The architecture of FIG. 3 includes a Customer (User) Engagement layer 301, an Event Based and Real Time Decision Engine layer 302, a Core BSS Components layer 303, an Insights & Batch Analytics layer 304, and an Infrastructure Management and Operational Platforms layer 305. Similar to the embodiment depicts in FIG. 2, each of the different layers in FIG. 3. may be configured as real-time event stream layers (e.g., Kafka event stream layers, etc.) via Event Stream 306 (e.g., Kafka event stream, etc.) and may be connected via an Open API 307. Additionally, the different architecture layers may include Management Components 308, including Digital Workflows 309, Security platforms 310, a Third Party API gateway 311, Log Management 312, Document Management 313, and Service Assurance 314, as described in relation to FIG. 2.

According to the embodiment depicted in FIG. 3, the Customer Engagement layer 301 (i.e., the layer which manage the interaction and engagement of customer (e.g., internal customer such as sales team, service team, management team, or external customer such as paying customer, etc.) with the system) may include an Advertisement Platform 301-1, an E-Commerce platform 301-2, a Mobile Applications platform 301-3, an E-Care Self-Service platform 301-4, a Kiosk and Display Advertisement platform 301-5, and a Media platform 301-6. The Event Based and Real Time Decision Engine layer 302 (i.e., the layer which provide event-base decisions) may include: an Automation Workflow platform 302-1, a Real Time Customer Data Platform 302-2, a Prescriptive Analytics platform 302-3, and a Predictive Analytics platform 302-4. The Core BSS Components layer 303 (i.e., the layer which comprise the core BSS components) may include: a Product Catalog 303-1, a Customer platform 303-2, a COM 303-2, a SOM 303-3, an Electronic Know-Your-Customer (eKYC) platform 303-4, a Customer Management platform 303-5, a Voucher & Coupon platform 303-6, an Inventory Management platform 303-7, a Quote Manager Sales Portal 303-8, a Rating & Charging platform 303-9, a Campaign & Lead Management platform 303-10, a Membership Loyalty platform 305-11, a Gaming platform 303-13, a Fraud Management platform 303-14, a Business-to-Business (B2B) Account Management platform 303-15, a Payment platform 303-16, and a Mediation platform 303-17. The Insights & Batch Analytics layer 304 (i.e., the layer which provide data processing and management) may include: a Data Lake 304-1, a Reporting Visualization platform 304-2, an Artificial Intelligence (AI) platform 304-3, an AI Assets 304-5, and a Descriptive Analytics platform 304-5. And the Infrastructure Management and Operational Platforms layer 305 (i.e., the layer which provide management and control on the required infrastructure, such as provisioning of databases which host the required cloud infrastructure) may include a Cloud Infrastructure & Network platform 305-1 and a Cloud Orchestration platform 305-2.

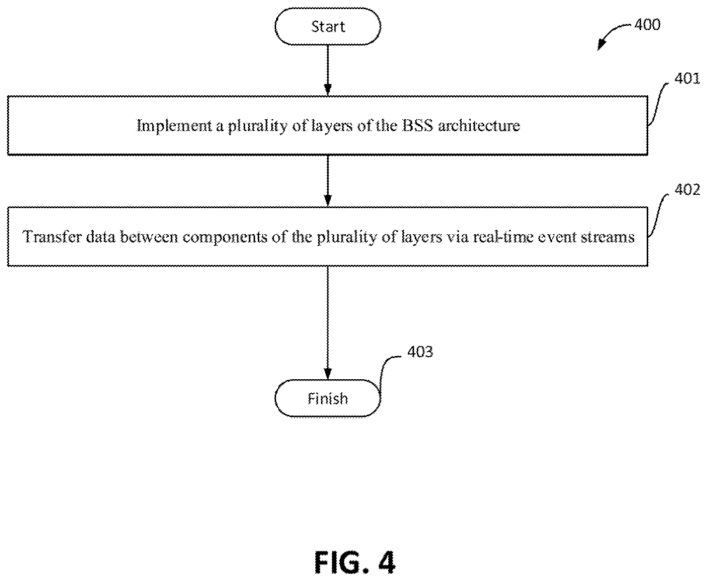

FIG. 4 illustrates a method 400 in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 401 may include implementing a business support system (BSS) architecture, and operation 402 may include transferring data between components of the plurality of layers via real-time event streams. The BSS architecture may correspond to the architecture described above with reference to FIGS. 2 and 3.

The above-described architecture in accordance with one or more embodiments allows for simplified implementation of multiple BSS use cases, as compared to customization of each use case and the BSS component layer in related art systems. The above-described architecture allows for the simplification and BSS solution orientation towards a Software-as-a-Service (SaaS) implementation model. The above-described architecture provides an improvement, as compared to related art systems, by allowing moving data across all the BSS components with the introduction of real time event streams (e.g., Kafka streams).

The above-described architecture involves a key component for digital evolution, namely the use of deploying a BSS solution as a SaaS solution while still providing the required product uniqueness (i.e., customized use cases specific to each operator) among operators. That is, the above-described BSS solution deployed as a SaaS solution allows an operator to launch services with lower upfront costs and a quicker time to market.

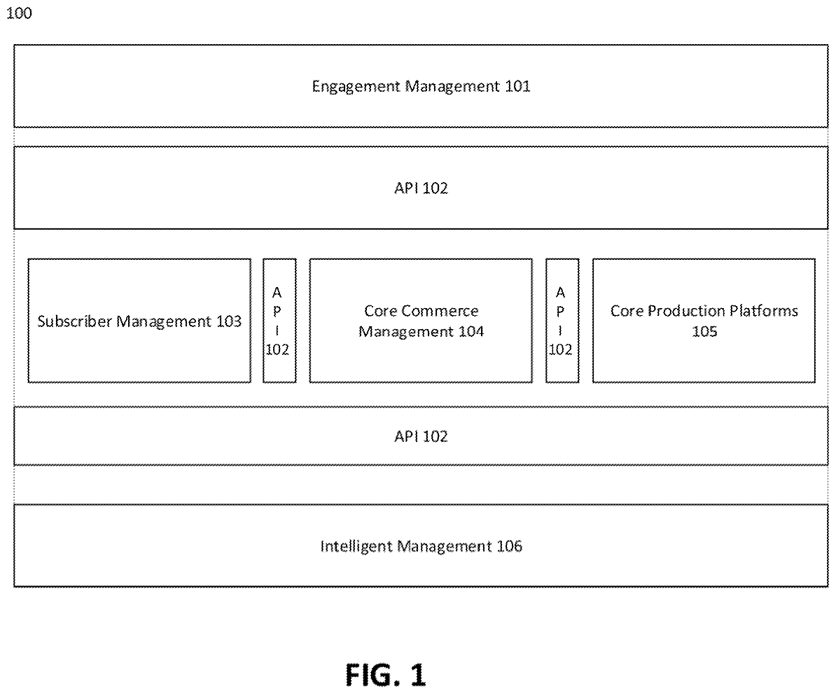

Additionally, the inclusion of event based capabilities using real time event streams (e.g., Kafka) allows efficient distribution of data across all components. Further the inclusion of automation workflow capabilities may provide a no code or low code layer for users to customize their own use cases. Relatedly, the introduction of real time analytics as part of the automation layer brings real time analytics closer to customer engagement layer. Further still, the implementations allow for the reduction of the need of extensive API calls across platforms, as compared to related systems such as shown in FIG. 1 which require excess API integration and calls to transfer data and interact between different layers or components of the BSS architecture. This reduces operation complexity and improves overall performance.

The table below provides a few examples/implementations of use cases which can be deployed in a more flexible and quicker time to market with the new proposed architecture approach.

TABLE 1

| | ODA According to | |
|---|---|---|
| Use Case | Embodiments/Implementations | Benefits of Disclosed ODA |
| Billing - Dunning | Executed in Event Based Layer using | Real Time execution and reduction |
| Process | workflow automation | of the complexity of Billing CR |
| | | processes. Flexibility to execute |
| | | customer specific dunning process. |
| Mobile number | Creation of virtual inventory to keep | Improved flexibility of proposing |
| selection during | track on available mobile numbers | new numbers. Reduces costs since |
| customer | | inventory solution CR are complex |
| registration | | and time consuming |
| Device Inventory | Creation of a virtual inventory based on | Real Time tracking of device |
| | real time events | inventory. Lesser dependency on |
| | | Inventory Management platforms |
| | | which would reduce the time to |
| | | market and customization cost. |
| Customer Profile | Real Time Customer Profile | Provides a real time view and the |
| Information | Information with real time event update | data can be exposed to any internal |
| | for data sync | platforms such as E-Care through |
| | | open API. Reduces the complexity |
| | | of Billing CR processes |
| Next Best Action | Real Time Analytics | Real Time offer decision is |
| or Offers | | possible for any customer event. |
| Inbound Call | Centralized model to decide the best | A quicker and standardized way to |
| Center and service | approach during channel engagement | implement automation. New use |
| center | | cases such as facial recognition at |
| Management | | Kiosk and service centers can be |
| | | introduced |
| Proactive | Real Time Analytics | Monitors all events in real time for |
| Customer Care | | a quicker response. Real time |
| | | recommendation for care agents. |
| Gaming | Automation workflow with Real Time | Provides more flexibility |
| | customer data capabilities | capabilities to create the required |
| | | use cases. Each of these use cases |
| | | would be unique based on |
| | | business user requirements. |
| Mobile Number | Automation Workflow | Since each country would have |
| Portability (MNP) | | their own process flow - the |
| Process Flow | | above-described architecture |
| | | provides a more flexible approach |
| | | to configure a MNP process flow. |
| Bill Usage | Online Charging Solution - complex | Real Time customer data with data |
| Threshold | usage tracking rule | streams. Provide more flexibility |
| Notification | | for any type of service usage |

The above-described architecture provides more flexibility to deploy BSS use cases while simplifying the overall ODA architecture, as compared to conventional systems. This allows operators (e.g., Telco operators) to quickly deploy a standard product-based SaaS BSS solution while still having the flexibility of deploying their own use cases. For BSS vendors, the architecture approach simplifies their efforts to develop and deploy a SaaS version of BSS products.

According to the above-described architecture, a BSS SaaS solution would involve a much lower initial investment, a quicker timeline to market, and the flexibility to expand as the customer needs grow, as compared to a conventional system.

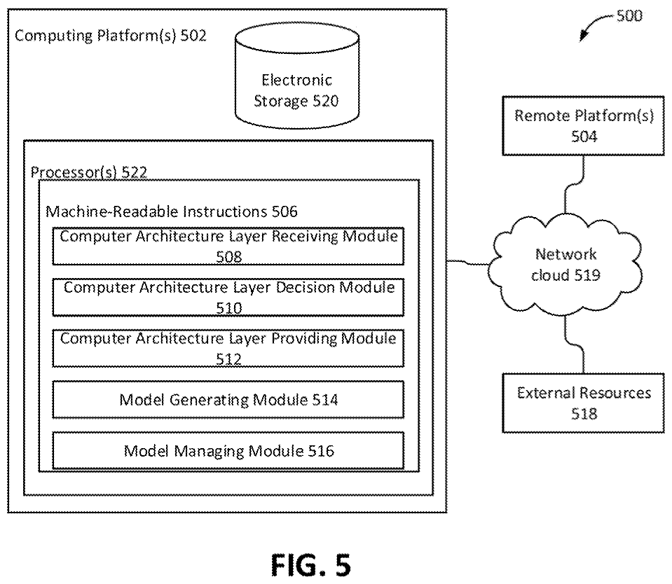

FIG. 5 illustrates a system 500 configured based on an enhanced open digital architecture (ODA) (100) for a support system, e.g., a Business Support System (BSS), in accordance with one or more implementations. In some implementations, system 500 may include one or more computing platforms 502. Computing platform(s) 502 may be configured to communicate with one or more remote platforms 504 according to a client/server architecture, a peer-to-peer architecture, and/or other architectures. Remote platform(s) 504 may be configured to communicate with other remote platforms via computing platform(s) 502 and/or according to a client/server architecture, a peer-to-peer architecture, and/or other architectures. Users may access computing platform(s) 502 via remote platform(s) 504.

Computing platform(s) 502 may be configured by machine-readable instructions 506, i.e., one or more instruction modules. The instruction modules (i.e., computer- or machine-readable instructions executable by at least one processor to perform corresponding functions) may include one or more of computer architecture layer receiving module 508, computer architecture layer decision module 510, computer architecture layer providing module 512, model generating module 514, model managing module 516, and/or other instruction modules.

Referring to FIG. 5, computer architecture layer receiving module 508 may be configured to receive, into a first computer architecture layer, a first user request. The first computer architecture layer may be a core commerce and customer engagement layer (such as shown in FIG. 2). The first user request may be a SaaS or BSS related request.

Computer architecture layer decision module 510 may be configured to decide, in real time, and via a second computer architecture layer, a category of the first user request. The second computer architecture layer may be an event based automation workflow layer (such as shown in FIG. 2). Also, the first computer architecture layer may be configurable based on the category of the first user request.

The second computer architecture layer allows for a combination of data from multiple sources and/or tools to create a centralized customer database (or databases) containing data on any and all touch points and interactions with a product or service. That database(s) can then be segmented in a nearly endless number of ways to create, e.g. personalized marketing campaigns.

Computer architecture layer providing module 512 may be configured to provide, based on the category of the first user request, and via the second computer architecture layer, an automated workflow and customer data platform for data entry and manipulation by the user. The user may make a second request.

Model generating module 514 may be configured to generate, via a third computer architecture layer, a productized model based on the second user request. The third computer architecture layer may be a core production platform layer (such as shown in FIG. 2).

Model managing module 516 may be configured to intelligently manage the productized model via a fourth computer architecture layer. The fourth computer architecture layer 204 may be an intelligent management layer (such as shown in FIG. 2). Additionally, internal reports may be centralized in the fourth computer architecture layer 204. The management of the productized model via the fourth computer architecture layer 204 may be centralized.

According to embodiments there may also be provided a fifth computer architecture layer, provided, e.g., as a cloud infrastructure management layer (such as shown in FIG. 2).

In some implementations, computing platform(s) 502, remote platform(s) 504, and/or external resources 518 may be operatively linked via one or more electronic communication links from a network cloud 519. For example, such electronic communication links may be established, at least in part, via a network such as the Internet and/or other networks. It will be appreciated that this is not intended to be limiting, and that the scope of this disclosure includes implementations in which computing platform(s) 502, remote platform(s) 504, and/or external resources 518 may be operatively linked via some other communication media.

A given remote platform 504 may include one or more processors configured to execute computer program modules. The computer program modules may be configured to enable an expert or user associated with the given remote platform 504 to interface with system 500 and/or external resources 518, and/or provide other functionality attributed herein to remote platform(s) 504. By way of non-limiting example, a given remote platform 504 and/or a given computing platform 502 may include one or more of a server, a desktop computer, a laptop computer, a handheld computer, a tablet computing platform, a NetBook, a Smartphone, a gaming console, and/or other computing platforms.

External resources 518 may include sources of information outside of system 500, external entities participating with system 500, and/or other resources. In some implementations, some or all of the functionality attributed herein to external resources 518 may be provided by resources included in system 500.

Computing platform(s) 502 may include electronic storage 520, one or more processors 522, and/or other components. Computing platform(s) 502 may include communication lines, or ports to enable the exchange of information with a network and/or other computing platforms. Illustration of computing platform(s) 502 in FIG. 5 is not intended to be limiting. Computing platform(s) 502 may include a plurality of hardware, software, and/or firmware components operating together to provide the functionality attributed herein to computing platform(s) 502. For example, computing platform(s) 502 may be implemented by a cloud of computing platforms operating together as computing platform(s) 502. Other implementations will be described in more detail below.

Electronic storage 520 may comprise non-transitory storage media that electronically stores information. The electronic storage media of electronic storage 520 may include one or both of system storage that is provided integrally (i.e., substantially non-removable) with computing platform(s) 502 and/or removable storage that is removably connectable to computing platform(s) 502 via, for example, a port (e.g., a USB port, a firewire port, etc.) or a drive (e.g., a disk drive, etc.). Electronic storage 520 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 520 may include one or more virtual storage resources (e.g., cloud storage, a virtual private network, and/or other virtual storage resources). Electronic storage 520 may store software algorithms, information determined by processor(s) 522, information received from computing platform(s) 502, information received from remote platform(s) 504, and/or other information that enables computing platform(s) 502 to function as described herein.

Processor(s) 522 may be configured to provide information processing capabilities in computing platform(s) 502. As such, processor(s) 522 may include one or more of a digital processor, an analog processor, a digital circuit designed to process information, an analog circuit designed to process information, a state machine, and/or other mechanisms for electronically processing information. Although processor(s) 522 is shown in FIG. 5 as a single entity, this is for illustrative purposes only. In some implementations, processor(s) 522 may include a plurality of processing units. These processing units may be physically located within the same device, or processor(s) 522 may represent processing functionality of a plurality of devices operating in coordination. Processor(s) 522 may be configured to execute modules 508, 510, 512, 514, and/or 516, and/or other modules. Processor(s) 522 may be configured to execute modules 508, 510, 512, 514, and/or 516, and/or other modules by software; hardware; firmware; some combination of software, hardware, and/or firmware; and/or other mechanisms for configuring processing capabilities on processor(s) 522. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 508, 510, 512, 514, and/or 516 are illustrated in FIG. 5 as being implemented within a single processing unit, in implementations in which processor(s) 522 includes multiple processing units, one or more of modules 508, 510, 512, 514, and/or 516 may be implemented remotely from the other modules. The description of the functionality provided by the different modules 508, 510, 512, 514, and/or 516 described below is for illustrative purposes, and is not intended to be limiting, as any of modules 508, 510, 512, 514, and/or 516 may provide more or less functionality than is described. For example, one or more of modules 508, 510, 512, 514, and/or 516 may be eliminated, and some or all of its functionality may be provided by other ones of modules 508, 510, 512, 514, and/or 516. As another example, processor(s) 522 may be configured to execute one or more additional modules that may perform some or all of the functionality attributed below to one of modules 508, 510, 512, 514, and/or 516.

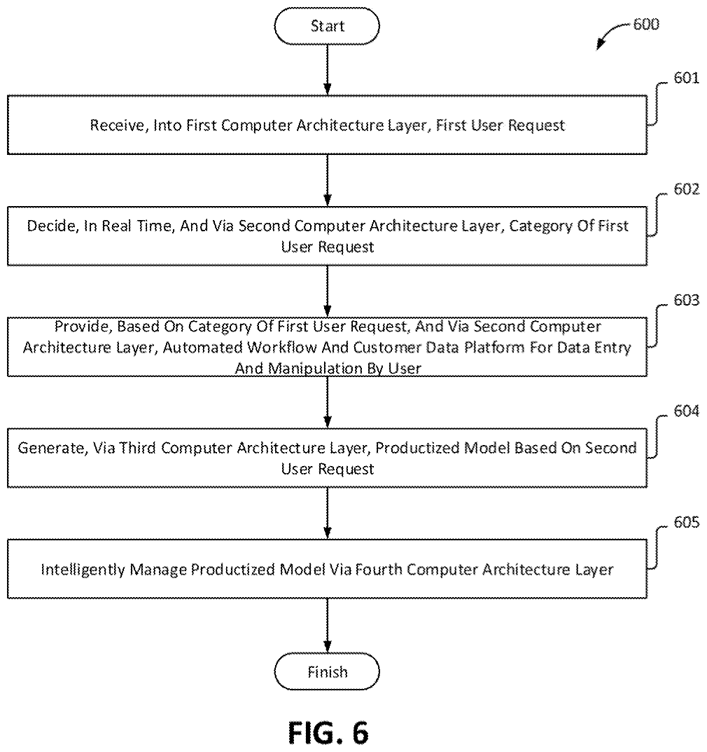

FIG. 6 illustrates a method 600 in accordance with one or more implementations. The operations of method 600 presented below are intended to be illustrative. In some implementations, method 600 may be accomplished with one or more additional operations not described, and/or without one or more of the operations discussed. Additionally, the order in which the operations of method 600 are illustrated in FIG. 6 and described below is not intended to be limiting.

In some implementations, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

An operation 601 may include receiving, into a first computer architecture layer, a first user request. Operation 601 may be performed by one or more hardware processors configured by machine-readable instructions including a module that is the same as or similar to computer architecture layer receiving module 508, in accordance with one or more implementations.

An operation 602 may include deciding, in real time, and via a second computer architecture layer, a category of the first user request. Operation 602 may be performed by one or more hardware processors configured by machine-readable instructions including a module that is the same as or similar to computer architecture layer decision module 510, in accordance with one or more implementations.

An operation 803 may include providing, based on the category of the first user request, and via the second computer architecture layer, an automated workflow and customer data platform for data entry and manipulation by the user. The user may make a second request through the automated workflow and customer data platform, e.g., a request to define a new automated workflow based on data from the customer data platform. Operation 803 may be performed by one or more hardware processors configured by machine-readable instructions including a module that is the same as or similar to computer architecture layer providing module 712, in accordance with one or more implementations.

An operation 604 may include generating, via a third computer architecture layer, a productized model (i.e., a model for implementing a use case as customized by the end user using the BSS ODA) based on the second user request. For example, the productized model may be an automated workflow in accordance with the second user request. Operation 604 may be performed by one or more hardware processors configured by machine-readable instructions including a module that is the same as or similar to model generating module 514, in accordance with one or more implementations.

An operation 605 may include intelligently managing the productized model via a fourth computer architecture layer. Operation 605 may be performed by one or more hardware processors configured by machine-readable instructions including a module that is the same as or similar to model managing module 516, in accordance with one or more implementations. The intelligent managing of the model may include integration with artificial intelligence models to feed inputs (e.g., inferences) or drive execution of the model automatically, data visualization of reports generated from the model (e.g., of data processed or output by the model), etc.

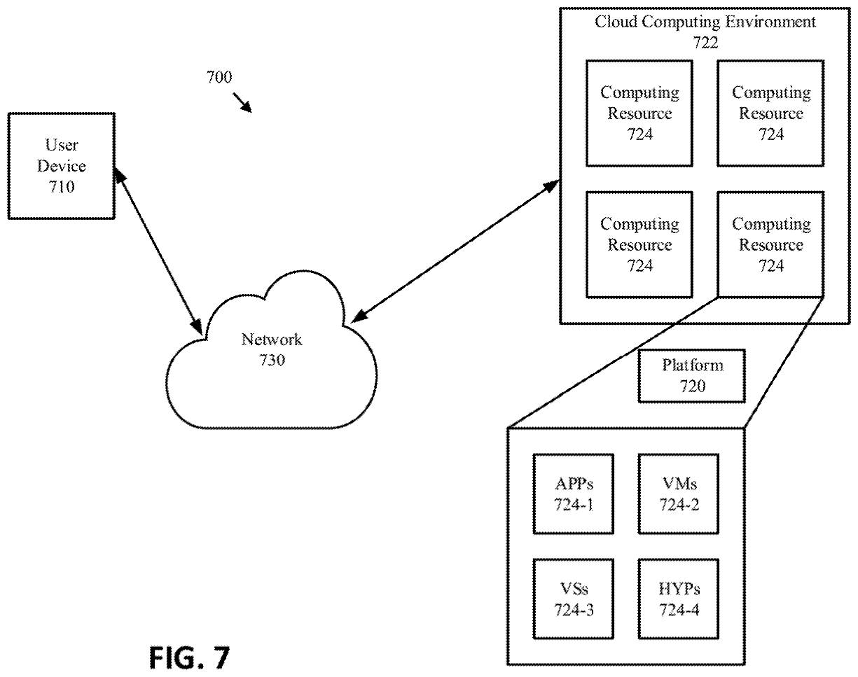

FIG. 7 is a diagram of an example environment 700 in which systems and/or methods, described herein, may be implemented. As shown in FIG. 5, environment 700 may include a user device 710, a platform 720, and a network 730. Devices of environment 700 may interconnect via wired connections, wireless connections, or a combination of wired and wireless connections. In embodiments, any of the functions and operations described with reference to FIGS. 4 and 6 above may be performed by any combination of elements illustrated in FIG. 7.

User device 510 includes one or more devices capable of receiving, generating, storing, processing, and/or providing information associated with platform 720. For example, user device 710 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 710 may receive information from and/or transmit information to platform 720.

Platform 720 includes one or more devices capable of receiving, generating, storing, processing, and/or providing information. In some implementations, platform 720 may include a cloud server or a group of cloud servers. In some implementations, platform 720 may be designed to be modular such that certain software components may be swapped in or out depending on a particular need. As such, platform 720 may be easily and/or quickly reconfigured for different uses.

In some implementations, as shown, platform 720 may be hosted in cloud computing environment 722. Notably, while implementations described herein describe platform 720 as being hosted in cloud computing environment 722, in some implementations, platform 720 may not be cloud-based (i.e., may be implemented outside of a cloud computing environment) or may be partially cloud-based.

Cloud computing environment 722 includes an environment that hosts platform 720. Cloud computing environment 722 may provide computation, software, data access, storage, etc. services that do not require end-user (e.g., user device 710) knowledge of a physical location and configuration of system(s) and/or device(s) that hosts platform 720. As shown, cloud computing environment 722 may include a group of computing resources 724 (referred to collectively as “computing resources 724” and individually as “computing resource 724”).

Computing resource 724 includes one or more personal computers, a cluster of computing devices, workstation computers, server devices, or other types of computation and/or communication devices. In some implementations, computing resource 724 may host platform 720. The cloud resources may include compute instances executing in computing resource 724, storage devices provided in computing resource 724, data transfer devices provided by computing resource 724, etc. In some implementations, computing resource 724 may communicate with other computing resources 724 via wired connections, wireless connections, or a combination of wired and wireless connections.

As further shown in FIG. 7, computing resource 724 includes a group of cloud resources, such as one or more applications (“APPs”) 724-1, one or more virtual machines (“VMs”) 724-2, virtualized storage (“VSs”) 724-3, one or more hypervisors (“HYPs”) 724-4, or the like.

Application 724-1 includes one or more software applications that may be provided to or accessed by user device 710. Application 724-1 may eliminate a need to install and execute the software applications on user device 710. For example, application 724-1 may include software associated with platform 720 and/or any other software capable of being provided via cloud computing environment 722. In some implementations, one application 724-1 may send/receive information to/from one or more other applications 724-1, via virtual machine 724-2.

Virtual machine 724-2 includes a software implementation of a machine (e.g., a computer) that executes programs like a physical machine. Virtual machine 724-2 may be either a system virtual machine or a process virtual machine, depending upon use and degree of correspondence to any real machine by virtual machine 724-2. A system virtual machine may provide a complete system platform that supports execution of a complete operating system (“OS”). A process virtual machine may execute a single program, and may support a single process. In some implementations, virtual machine 724-2 may execute on behalf of a user (e.g., user device 710), and may manage infrastructure of cloud computing environment 722, such as data management, synchronization, or long-duration data transfers.

Virtualized storage 724-3 includes one or more storage systems and/or one or more devices that use virtualization techniques within the storage systems or devices of computing resource 724. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 724-4 may provide hardware virtualization techniques that allow multiple operating systems (e.g., “guest operating systems”) to execute concurrently on a host computer, such as computing resource 724. Hypervisor 724-4 may present a virtual operating platform to the guest operating systems, and may manage the execution of the guest operating systems. Multiple instances of a variety of operating systems may share virtualized hardware resources.

Network 730 includes one or more wired and/or wireless networks. For example, network 730 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

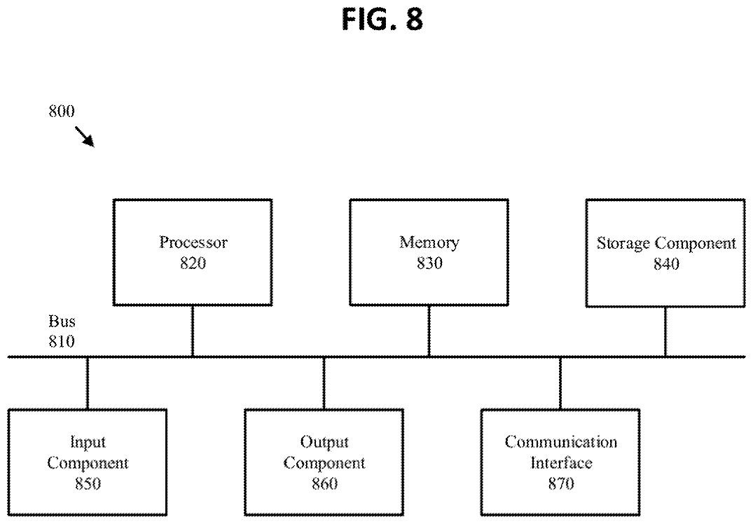

FIG. 8 is a diagram of example components of a device 800. Device 800 may correspond to user device 810 and/or platform 820. As shown in FIG. 8, device 800 may include a bus 810, a processor 820, a memory 830, a storage component 840, an input component 850, an output component 860, and a communication interface 870.

Bus 810 includes a component that permits communication among the components of device 800. Processor 820 may be implemented in hardware, firmware, or a combination of hardware and software. Processor 820 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 820 includes one or more processors capable of being programmed to perform a function. Memory 830 includes a random access memory (RAM), a read only memory (ROM), and/or another type of dynamic or static storage device (e.g., a flash memory, a magnetic memory, and/or an optical memory) that stores information and/or instructions for use by processor 820.

Storage component 840 stores information and/or software related to the operation and use of device 800. For example, storage component 840 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 850 includes a component that permits device 800 to receive information, such as via user input (e.g., a touch screen display, a keyboard, a keypad, a mouse, a button, a switch, and/or a microphone). Additionally, or alternatively, input component 850 may include a sensor for sensing information (e.g., a global positioning system (GPS) component, an accelerometer, a gyroscope, and/or an actuator). Output component 860 includes a component that provides output information from device 800 (e.g., a display, a speaker, and/or one or more light-emitting diodes (LEDs)).

Communication interface 870 includes a transceiver-like component (e.g., a transceiver and/or a separate receiver and transmitter) that enables device 800 to communicate with other devices, such as via a wired connection, a wireless connection, or a combination of wired and wireless connections. Communication interface 870 may permit device 800 to receive information from another device and/or provide information to another device. For example, communication interface 870 may include an Ethernet interface, an optical interface, a coaxial interface, an infrared interface, a radio frequency (RF) interface, a universal serial bus (USB) interface, a Wi-Fi interface, a cellular network interface, or the like.

Device 800 may perform one or more processes described herein. Device 800 may perform these processes in response to processor 820 executing software instructions stored by a non-transitory computer-readable medium, such as memory 830 and/or storage component 840. A computer-readable medium is defined herein as a non-transitory memory device. A memory device includes memory space within a single physical storage device or memory space spread across multiple physical storage devices.

Software instructions may be read into memory 830 and/or storage component 840 from another computer-readable medium or from another device via communication interface 870. When executed, software instructions stored in memory 830 and/or storage component 840 may cause processor 820 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800.

In embodiments, any one of the operations or processes of FIGS. 4 and 6 may be implemented by or using any one of the elements illustrated in FIGS. 7 and 8.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A system for implementing a business support system (BSS) architecture, the system comprising:
at least one memory storing instructions; and
at least one processor configured to execute the instructions to implement the BSS architecture, the BSS architecture comprising:
a plurality of layers, and
real-time event streams for transferring real-time event streams of data between components of the plurality of layers,
wherein the plurality of layers comprises:
an engagement and core commerce management layer for providing a plurality of user interfaces respectively corresponding to a plurality of use cases for the BSS architecture;
an event based automation and user data platform layer comprising a real-time customer data platform (CDP) and a plurality of automation workflows for executing the plurality of use cases based on real-time data from the CDP;
a core BSS components layer comprising core BSS components;
an intelligent management layer for managing insights, model development and execution of batch models; and
a cloud infrastructure management layer configured to provide cloud functionality for a Software as a Solution (SaaS) implementation of the BSS architecture.

2. The system according to claim 1, wherein the BSS architecture further comprises an Open Application Programming Interface (API) for real time information provisioning of the data between the components.

3. The system according to claim 1, wherein the real-time event streams are Kafka event streams.

4. The system according to claim 1, wherein the BSS architecture further comprises management components used across the plurality of layers.

5. The system according to claim 1, wherein the plurality of user interfaces are respectively configurable by a customer of the SaaS implementation without hardcoding.

6. The system according to claim 1, wherein the BSS components are productized to the SaaS implementation.

7. The system according to claim 1, wherein the components of the plurality of layers are executable as microservices by the at least one processor.

8. A method for implementing a business support system (BSS) architecture, the method comprising:
executing, by at least one processor, instructions to implement a plurality of layers of the BSS architecture; and
transferring data between components of the plurality of layers via real-time event streams,
wherein the plurality of layers comprises:
an engagement and core commerce management layer for providing a plurality of user interfaces respectively corresponding to a plurality of use cases for the BSS architecture;
an event based automation and user data platform layer comprising a real-time customer data platform (CDP) and a plurality of automation workflows for executing the plurality of use cases based on real-time data from the CDP;
a core BSS components layer comprising core BSS components;
an intelligent management layer for managing insights, model development and execution of batch models; and
a cloud infrastructure management layer configured to provide cloud functionality for a Software as a Solution (SaaS) implementation of the BSS architecture.

9. The method according to claim 8, wherein the BSS architecture further comprises an Open Application Programming Interface (API) for real time information provisioning of the data between the components.

10. The method according to claim 8, wherein the real-time event streams are Kafka event streams.

11. The method according to claim 8, wherein the BSS architecture further comprises management components used across the plurality of layers.

12. The method according to claim 8, wherein the plurality of user interfaces are respectively configurable by a customer of the SaaS implementation without hardcoding.

13. The method according to claim 8, wherein the BSS components are productized to the SaaS implementation.

14. The method according to claim 8, wherein the components of the plurality of layers are executable as microservices by the at least one processor.

15. A non-transient computer readable storage medium having instructions embodied thereon, the instructions being executable by one or more processors to perform a method, the method comprising:
executing, by the at least one processor, instructions to implement a plurality of layers of a business support system (BSS) architecture; and
transferring data between components of the plurality of layers via real-time event streams,
wherein the plurality of layers comprises:
an engagement and core commerce management layer for providing a plurality of user interfaces respectively corresponding to a plurality of use cases for the BSS architecture;
an event based automation and user data platform layer comprising a real-time customer data platform (CDP) and a plurality of automation workflows for executing the plurality of use cases based on real-time data from the CDP;
a core BSS components layer comprising core BSS components;
an intelligent management layer for managing insights, model development and execution of batch models; and
a cloud infrastructure management layer configured to provide cloud functionality for a Software as a Solution (SaaS) implementation of the BSS architecture.

16. The computer readable storage medium of claim 15, wherein the BSS architecture further comprises an Open Application Programming Interface (API) for real time information provisioning of the data between the components.

17. The computer readable storage medium of claim 15, wherein the real-time event streams are Kafka event streams.

18. The computer readable storage medium of claim 15, wherein the BSS architecture further comprises management components used across the plurality of layers.

19. The computer readable storage medium of claim 15, wherein the plurality of user interfaces are respectively configurable by a customer of the SaaS implementation without hardcoding.

20. The computer readable storage medium of claim 15, wherein the BSS components are productized to the SaaS implementation.
